(19) United States
(12) Patent Application Publication
(10) Pub. No.: US 2008/0145502 A1
(43) Pub. Date: Jun. 19, 2008

(54) Method for the Enrichment and Supplementation of Olive Oils with Organic Antioxidants, Product Obtained Thereby and System for Implementing Said Method

(76) Inventors: Franco Francesco Vincieri, Firenze (IT); Annalisa Romani, Pistoia (IT); Nadia Mulinacci, Prato (IT)

Correspondence Address: MCGLEW & TUTTLE, PC, P.O. BOX 9227, SCARBOROUGH STATION, SCARBOROUGH, NY, 10510-9227, US

(21) Appl. No.: 11/816,488

(22) PCT Filed: Jan. 17, 2006
(86) PCT No.: PCT/IT06/00021

§ 371 Date: Aug. 16, 2007

(30) Foreign Application Priority Data
Feb. 21, 2005 (IT) FI2005A000029

(51) Int. Cl. C11B 5/00; A23D 7/00; B01J 19/10

(52) U.S. Cl. 426/545; 426/601; 426/546; 426/607; 99/451

(57) ABSTRACT

The product is enriched and supplemented with natural extracts and organic additives comprising organic antioxidants consisting of fractions of biophenols of vegetable origin, preferably different from those existing naturally in olive oil, by means of the anhydrification of the natural extracts and their solubilization in glycerol water in proportions of 1:1.

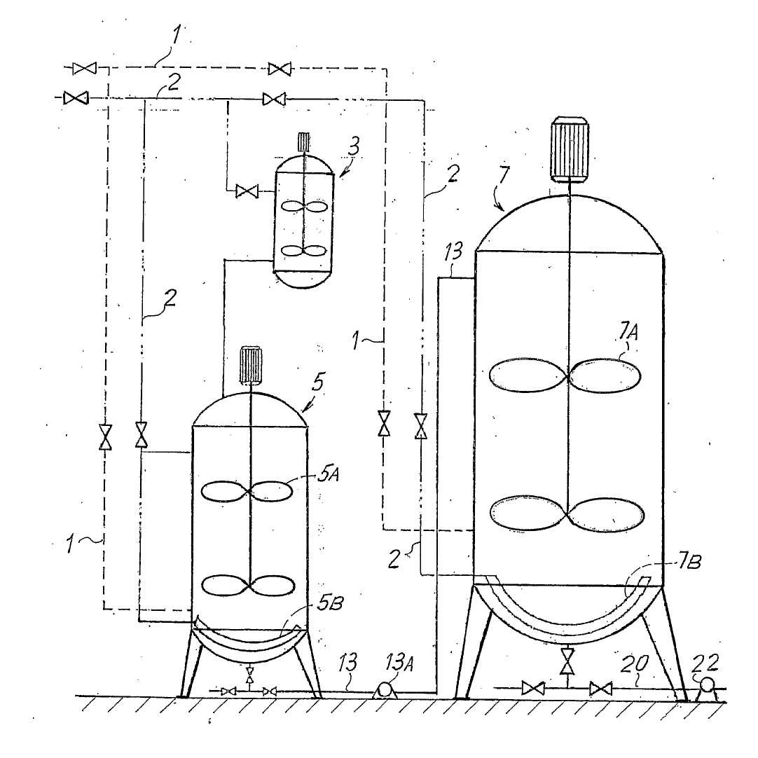

The present invention relates to a method designed to obtain a product based on olive oil, virgin olive oil, or extra virgin olive oil, incrementing its antioxidant and health-giving properties.

The present invention also relates to the product obtained by means of said method, and to a system for implementing said method.

The method substantially comprises stages of: anhydrification of the extracts and their solubilization in glycerol/water in proportions of 1:1; mixing, advantageously achieved with the aid of ultrasound; and the addition of the antioxidant fraction (consisting of vegetable biophenols) to the oil in two subsequent stages, while stirring and in the presence of inert gas flows (an upward flow of nitrogen, to be more specific).

The resulting end product consists of a homogeneous, clear fluid that has a higher antioxidant potential than the original oil, effective both in stabilizing the product and for its potential health-giving effects on humans.

The added fractions consist of biophenols of vegetable origin, preferably different from those occurring naturally in olive oil. The choice of the new medium, which consists of glycerol and water, enables 300 mg of green tea biophenol extract to be dissolved in one liter of oil.

The added quantity of biophenols thus consists in much the same content as the one occurring naturally in a typical Italian oil, consequently giving rise to an approximately 50% increment, with a crucial effect in terms of both the antioxidant effect (and consequently of product stability) and from the health-giving standpoint.

These compounds, which are scarcely soluble or entirely insoluble in oil, enable an increase in the antioxidant capacity and health-giving properties of the oil, in view of the fact that the gallocatechins in green tea, and particularly epigallocatechin gallate—the most abundant compound in the extract considered—are described in the literature as the most active antioxidant molecule among the natural polyphenolic compounds studied to date.

It is also possible to add ascorbyl-6-palmitate (vitamin C palmitate) both as an antioxidant and as an adjuvant to promote the solubilization of the biophenol extracts. Mixtures of omega-3 fatty acids may also be added.

To be more specific, the method for treating the olive oil, or virgin olive oil or extra virgin olive oil, enriched with vegetable biophenol extracts as described above, comprises the following stages:
the biophenol fractions are dried for 24 hours in a dryer, to ensure a fine dispersion of the powder constituting the extract;
the phenolic fraction is dissolved in the dispersing mixture consisting of glycerol/water in proportions of 1:1 V/V, said solution-dispersion of the biophenols being achieved with the aid of ultrasound for approximately 10 minutes in the presence of an inert gas atmosphere, at a temperature coming between 25 and 35° C., depending on the formulation chosen;
an adequate quantity of oil (previously filtered in the case of extra virgin or virgin oils), sufficient to sustain a dispersion of the enriching substances up to 100 times greater than the concentration that will be obtained in the end product, is prepared in a stainless steel thermostatic container complete with a mixer and a suitable nitrogen sparger;
the mixer is operated while the glycerol/water solution enriched with biophenols is added to the oil by gravity from above, adding approximately 0.3% of monoesters of glycerol with fatty acids, e.g. oleic, palmitic or stearic, at the same time;
the mixing rate is brought up to the established maximum speed, depending on the type of formula being prepared, and maintained for 20-25 minutes in order to obtain a fine emulsion (to guarantee an adequate homogeneity of the product, the stirring process is also continued during the next step);
the above-mentioned fine emulsion is transferred to a third and final, large-capacity container, where the established final concentration is obtained; the product is stirred mechanically, both during and after the above-mentioned addition of the premixed fine emulsion, for at least 20-25 minutes in controlled-temperature conditions and in the presence of a nitrogen sparger.

The attached drawing schematically illustrates a system for implementing the above method.

In the drawing, the numeral 3 is used to indicate a reactor and 3 and 5 and 7 identify two containers. The numeral 1 is used to indicate the line for delivering the oil to treat, to the two containers 5 and 7, with suitable control valves. The numeral 2 is used to indicate the line for delivering nitrogen (or other inert gas) to the reactor 3 and the containers 5 and 7.

Inside the reactor 3, the above-mentioned previously-dried, vegetable biophenol extracts are dissolved in the dispersing mixture consisting of glycerol and water in proportions of 1:1 V/V contained in the reactor 3. The dissolving-dispersion process in the reactor 3 is achieved with the aid of ultrasound for approximately 10 minutes, in the presence of an inert gas atmosphere at temperatures coming between 25 and 35° C., depending on the formula being prepared. The mixture coming from the reactor 3 is slowly transferred by gravity into the container 5—which has a capacity of around 50 liters and is complete with a mixer 5A. A sufficient quantity of filtered oil is added to the container 5, to obtain a dispersion of the enriching substances up to 100 times greater than the concentration that is to be obtained in the end product; using a sparger 5B, the content of the container is gassed with nitrogen. The oil is then transferred—through the line 13 with the pump 13A—from the container 5 to the stainless steel thermostatic container 7, complete with a mixer 7A and a sparger 7B for gassing with nitrogen, in order to ensure a homogeneous dispersion of the gas in the oil being treated. The oil treated in the container 5 is delivered into the upper part of the container 7. The oil treated in the container 7 is then transferred with a line 20 and a pump 22 to a storage system. While the mixture is being delivered from the reactor 3 to the container 5 (by gravity from above), approximately 0.3% of glycerol monoesters containing oleic, palmitic or stearic fatty acids can also be added at the same time. The mixing rate is accelerated up to maximum speed (established according to the type of formula being used) and maintained for 20-25 minutes to obtain a fine emulsion, in order to ensure an adequate homogeneity of the product.

It is worth noting that the optimization of the production process involves:
rapidly dissolving of the biophenols in the dispersing medium, with the aid of ultrasound in an inert gas atmosphere in order to guarantee the maximum integrity of the added antioxidant molecules;
the choice of solubilizing mixture and a further simultaneous addition of natural emulsifiers, such as the monoglycerides of fatty acids (e.g. palmitic, oleic and stearic acid), in quantities no greater than 0.3% of the end product, afford the resulting end product a clear and stable appearance (the product shows no signs of sediment even in the long term);
the use of inert gas homogeneously dispersed in an upward flow through the containers, during the stages of the process also helps to maintain the stability of the minor polar compounds and of all the other added antioxidants in the oil, thereby ensuring, by comparison with the normal oil production and storage conditions, the virtually total removal of oxygen, which is an oxidizing agent that places the chemical and organoleptic characteristics, and the stability of the oil at risk.

To better clarify the features and results of the present invention, the following is a description of the constituent components of the new formulations.

### Extra Virgin Olive Oil

Extra virgin olive oil differs distinctly from the other vegetable oils, both in macronutrient composition—because it is rich in monounsaturated fatty acids (more than 70% of oleic acid)—and also because virgin and extra virgin olive oils are the only vegetable oils to naturally contain appreciable amounts of phenolic compounds at consumption.

The main phenolic compounds in extra virgin olive oil and virgin olive oil are: tyrosol, hydroxytyrosol and, above all, numerous secoiridoid derivatives with a phenolic nucleus, which often account for up to 60-80% of all the minor polar compounds (MPC). In lesser quantities, there are also flavonoid phenolic acids, such as apigenin and luteolin [Romani A et al., HPLC and HRGC analyses of polyphenols and secoiridoids in olive oil. Chromatographia, 53: 279-284 (2001); Pinelli P., et al., Minor polar compounds and fatty acid analyses in monocultivar virgin olive oils from Tuscany. Food Chem 80: 331-336 (2003); Mulinacci N., et al. Analysis of extra virgin olive oils from stoned olives. J Science Food Agric (2005) in press].

According to recent works focusing on the qualitative and quantitative determination of the minor polar compounds (MPC) in virgin and extra virgin olive oil, the total content can vary considerably, depending on various factors including the type of cultivar, the area of cultivation, and the olive ripening time [Romani A., et al. Polyphenol content in five Tuscany cultivars of Olea europaea I. J Agric Food Chem 47: 964-967, 1999], the crushing and pressing methods [Salvador M. D., et al. Influence of extraction system, production year and area on Cornicabra virgin olive oil: a study of five crop seasons. Food Chem 80: 359-366 (2003)]. To be more specific, for Tuscan oils sampled by November the MPC content ranges between 200 mg/kg and 400 mg/kg, while for samples collected in December it is around 150 mg/kg, and oils coming from specific areas and/or selected cultivars can have more than 600 mg/kg of total MPC. Comparing these results with findings relating to Italian oils from other regions, it is reasonable to assume that the total MPC content averages around 300˜mg/kg [Romani A et al., HPLC and HRGC analyses of polyphenols and secoiridoid in olive oil. Chromatographia, 53: 279-284 (2001); Mulinacci N., et al., Analysis of extra virgin olive oils from stoned olives. J Science Food Agric (2005) in press].

The phenolic fraction of extra virgin olive oil also strongly influences its organoleptic characteristics and product quality. These molecules are largely responsible for the stability of extra virgin and virgin olive oil, which they make more resistant both to natural oxidation and to thermo-oxidation, also helping to increase the shelf-life of the product [Caponio F., et al. Phenolic compounds of virgin olive oils: influence of the degree of olive ripeness on organoleptic characteristics and shelf-life. Eur Food Res Technl 212: 329-333 (2001)].

Epidemiological studies conducted mainly on populations in the Mediterranean basin have identified a correlation between the consumption of olive oil and a reduction in cardiovascular risk [Stark A H and Madar Z., Olive oil as a functional food: epidemiology and nutritional approaches. Nutr Rev 60: 170-176 (2002); Hu F B, The Mediterranean diet and mortality—olive oil and beyond. N Engl J Med 26: 348 (26): 2595-2608 2003; Visioli F. et al., Antioxidant and other biological activities of phenols from olives and olive oil. Med Research Reviews 22: 65-75 2002]. According to recent studies, the dietary consumption of olive oil and olives of the populations of southern Europe could also play an important part in reducing the incidence of certain forms of neoplastic disease [Owen R W, et al., Olives and olive oil in cancer prevention. Eur J Cancer Prev. 13 (4): 319-26, 2004]. Among the phenolic molecules, moreover, a potential role has been suggested for OH-tyrosol in protecting the DNA against oxidative damage both in vitro [Deiana M., et al., Inhibition of peroxynitrite dependent DNA base modification and tyrosine nitration by extra virgin olive oil-derived antioxidant hydroxytyrosol. Free Rad. Biol. Med.; 26(5, 6):762-9, 1999] and in vivo [Weinbrenner T et al., Olive oils high in phenolic compounds modulate oxidative/antioxidative status in men. J. Nutr. 134 (9): 2314-21, 2004].

Finally, the FDA recently announced (November 2004) that olive oil ingested in the diet in quantities of approximately 25 g a day can contribute to reducing the risk of the onset of cardiovascular disease in the population, especially by virtue of its high monounsaturated fatty acid content (oleic acid>70%).

Phenolic Compounds

Numerous plants, such as: Vitis vinifera, Camellia sinensis, Cynara scolymus, Origanum vulgaris, Origanum majorana, Menta piperita, Olea europaea L., Rosmarinus officinalis, Salvia officinalis, Rosa canina, Thymus vulgaris, Glycine soja, and Glycine max, Pinus pinaster or Pinus maritima, are used in the preparation of natural extracts containing phenolic compounds with a strong antioxidant effect.

Recently, in the nutritional and dietary field, the most widely used extracts as a source of phenolic compounds have been: procyanidine extract from the leaves of Camellia sinensis (green tea), procyanidine extract from grape pips of Vitis vinifera, polyphenol extracts from citrus fruits, leaf extract from Cynara scolymus and bark extract from Pinus pinaster or Pinus maritima, etc.

Many studies have demonstrated that, among the phenolic compounds, those revealing the greatest antioxidant and anti-free radical effect are procyanidines, and particularly the ones esterified with gallic acid. The natural extracts containing polyphenol molecules of this nature are the extracts of Vitis vinifera and, even more, of Camellia sinensis (green tea), which contain a larger quantity of procyanidines esterified with gallic acid. The main catechins in green tea extract are epigallocatechin 3-O-gallate, epigallocatechin and epicatechin 3-O-gallate. Not only numerous in vitro studies, but also animal models have provided experimental evidence of the protective role of the catechins in green tea in reducing the risk of onset of pathologies such as liver diseases, breast cancer and cardiovascular system disorders [Crespy V and Williamson G., A review of the health effects of green tea catechins in in vivo animal models, J. Nutr., 134 (12): 3431S-3440S, 2004].

Recent data have shown that the catechins of green tea act as inhibitors of various growth factors involved in the development of atherosclerosis, exerting an antiproliferative effect [Gouni-Berthold I and Sachinidis, Molecular mechanisms explaining the preventive effects of catechins on the development of proliferative diseases, Curr Pharm Des.; 10 (11): 1261-71, 2004]. Research conducted on animals has shown that green tea catechins are capable of inhibiting one or more phases in the process of neoplastic development [Chung-Fung-Lung et al., Tea and cancer prevention: studies in animals and humans. J. Nutr., 133, 3268s-3274s, 2003]. The National Cancer Institute has selected the green tea catechins as one of the most promising bioactive components in foodstuffs for the development of clinical trials to evaluate their effect in reducing the risk of breast cancer [Greenwald P., Clinical trials in cancer prevention: current results and perspectives for the future. J Nutr. 134 (12): 3507S-3512S, 2004.].

Finally, several authors have demonstrated that the daily dietary intake of green tea as a beverage or food supplement has led to a modest, but significant increase in the total antioxidant capacity of the human plasma [Henning S. M. et al., Bioavailability and antioxidant activity of tea flavanols after consumption of green tea, black tea, or a green tea extract supplement. Am J Clin Nutr. 80 (6): 1558-64, 2004].

Ascorbyl-6-palmitate

The use of (vitamin C palmitate) represents a novelty because it guarantees a greater stability of the product by helping to optimize the solubilization of the biophenols in the oil (thanks to its surfactant properties) and by adding to the oil a water-soluble vitamin known for its antioxidant action (vitamin C). Vitamin C palmitate is included in the list of antioxidants allowable for use in the nutritional field (Ministerial Decree No. 209 of 27/02/1996, transposing the European Community directives).

The Production Process

The method according to the invention is further explained below. It comprises the following phases, with reference to the products used in the various formulations according to the invention:
the polyphenols are dried for 24 hours in a dryer, in order to guarantee a fine dispersion of the powder forming the biophenol extract;
the dried polyphenols are solubilized in glycerol/water in proportions of 1:1 V/V, in a small first mixer, maintaining the product under an evenly-distributed flow of inert gas in an ultrasound bath for approximately 10 minutes, at a suitable temperature (depending on the chosen formulation) and in any case never exceeding 30° C.;
an adequate quantity of oil is prepared (previously filtered in the case of extra virgin or virgin olive oil) sufficient to support a dispersion of the enriching substances 100 times greater than the concentration to obtain in the end product;
the product mixed as described above (biophenols in glycerol/water) is transferred by gravity by means of a conduit that delivers the concentrated mixture into the upper part of a tank containing the necessary quantity of the aforementioned oil and complete with: temperature control, double mixing blades turning in opposite directions, which turn at an increasing speed up to 90/120 rpm for at least 20-25 minutes, a nitrogen sparger, where a concentration corresponding to at least 100 times that of the end product is obtained in a homogeneous mixture;
an adequate quantity of oil is prepared in a further thermostatic container, complete with an inert gas (nitrogen) sparger and double mixing blades turning in opposite directions at increasing speed up to 90-120 rpm;
approximately 15 minutes after adding all the biophenol mixture to the first tank containing the oil, the premixed product (as described above) is transferred by means of a conduit and a pump into the upper part of the next oil container tank, where the required final concentration is obtained, and a low-speed rotational mixing is enabled, progressively increasing the mixing speed up to the maximum established speed (up to 90/120 rpm for at least 20-25 minutes), depending on the type of formula being prepared, in controlled-temperature conditions and in the presence of nitrogen spargers, to ensure the complete homogenization of the product, and also to prolong the nitrogen flushing for about 20 minutes after completing the process so as to reduce the oxygen content to a minimum.

Example of the Preparation of a Basic Formula with Some Possible Variations

The following antioxidants were added to samples of extra virgin olive oil:
dry extracts of green tea procyanidines
standardized extracts of grape procyanidines
standardized extracts in phenolic products deriving from Olea europaea L.
standardized biophenol bark extracts of Pinus pinaster L. or Pinus maritima L.
standardized extracts of soybean and the like
ascorbyl-6-palmitate (vitamin C palmitate)
standardized extracts of omega 3 fatty acids.

The 1:1 v/v glycerol/water mixture was used as a technological adjuvant for the accelerated solubilization of compounds that are scarcely soluble or entirely insoluble in oil.

The basic formula was prepared as follows: the decaffeinated extract of green tea procyanidines was kept in the dryer for 24 hours; 300 mg of this extract were dissolved in 1.0 mL of glycerol/water in proportions of 1:1 v/v, using an ultrasound bath at room temperature for approximately 10 minutes under a flow of inert gas (nitrogen) until a clear solution was obtained. This solution was added to one liter of previously-filtered virgin olive oil, containing ascorbyl 6-palmitate (from 10 to 50 mg/L) and maintained, at a suitable temperature (25-30° C.), mechanically stirred in a flow of inert gas until a homogeneous mixture was obtained.

Various samples containing green tea procyanidine extracts were obtained in concentrations coming between 100 and 300 mg/L of oil. The following tests, both on the basic formula and on the formulas numbered as No. 1, 2, 3, 4, 5, were also conducted in the same conditions using virgin oils and olive oils.

Example of Preparation of the Formula No. 1

A standardized, previously dried Olea europaea L. phenol extract was added to the basic formula in concentrations coming within the range of 20 and 40 mg/L. This extract was added to the glycerol-water solution of the green tea procyanidine extract, and the resulting mixture was subsequently added to the sample of extra virgin olive oil.

Example of Preparation of the Formula No. 2

A standardized Pinus pinaster or Pinus maritima L. bark procyanidine extract was added to the basic formula in concentrations coming within the range of 20 to 30 mg/L. This extract was added to the glycerol-water solution of the green tea procyanidine extract and the resulting mixture was subsequently added to the sample of extra virgin olive oil.

Example of Preparation of the Formula No. 3.

A commercially-available dry extract of grape pip procyanidine was added to the basic formula in concentrations coming within the range of 20 and 30 mg/L. This extract was added to the glycerol-water solution of the green tea procyanidine extract and the resulting mixture was subsequently added to the sample of extra virgin olive oil.

Example of Preparation of the Formula No. 4.

A dry extract of Cynara scolymus polyphenols was added to the basic formula in concentrations coming within the range of 20 and 40 mg/L. This extract was added to the glycerol-water solution of the green tea procyanidine extract and the resulting mixture was subsequently added to the sample of extra virgin olive oil.

Example of Preparation of the Formula No. 5.

A commercially-available standardized dry extract of soybean was added to the basic formula in concentrations coming within the range of 20 and 30 mg/L. This extract was added to the glycerol-water solution of the green tea procyanidine extract and the resulting mixture was subsequently added to the sample of extra virgin olive oil.

In short, by comparison with known techniques, the present invention achieves a plurality of objects and advantages, including:
a rapid dispersion and solubilization of the polyphenols;
the opportunity to add omega-3 fatty acids;
a substantial reduction in the presence of oxygen (and the consequent risk of oxidation) thanks mainly to the effect of the nitrogen;
a substantial increase in the final concentration of polyphenols, which have antioxidant properties;
a longer shelf-life of the polyphenols in the oil, with no appreciable change in the organoleptic qualities of the end product;
a longer shelf-life of the unsaturated acids in the oil, with reference to their oxidation processes.

1. Method for enriching and supplementing olive oils, even virgin and extra virgin olive oils, with natural extracts and organic additives, comprising anhydrification of said extracts and their solubilization in glycerol/water in proportions of 1:1 V/V.

2. Method for enriching and supplementing olive oils, even virgin and extra virgin olive oils, with natural extracts and organic additives, comprising organic antioxidants consisting of fractions of biophenols of vegetable origin (preferably other than those naturally existing in the olive oil), by including anhydrification of the extracts and solubilization in a medium based on glycerol/water in proportions of 1:1, mixing and then adding an antioxidant fraction consisting of vegetable biophenols to the oil in two subsequent stages, stirring meanwhile.

3. Method as claimed in claim 2, wherein the mixing is done with the aid of ultrasound.

4. Method as claimed in claim 2, wherein, during said mixing and adding stages at least, the product is submitted to the action of a flow of nitrogen.

5. Method as claimed in claim 2, wherein 300 mg of green tea biophenol extract per liter of oil is dissolved in said medium, thus obtaining an approximately 50% increase in a typical oil, thereby increasing the antioxidant effect and beneficial properties of the oil.

6. Method as claimed in claim 1, further comprising addition of ascorbyl-6-palmitate (vitamin C palmitate) both as an antioxidant and to facilitate the solubilization of the biophenol extracts.

7. Method as claimed in claim 1, further comprising addition of mixtures of omega-3 fatty acids.

8. Method as claimed in claim 1, further comprising the following steps:
drying the biophenol fractions for 24 hours in a dryer;
dissolving the phenolic fraction in a dispersing medium consisting of glycerol/water in proportions of 1:1 V/V, inside a first tank;
dissolving and dispersing the biophenols in the dispersing medium with the aid of ultrasound for approximately 10 minutes in an inert gas atmosphere and at a temperature coming between 25 and 35° C.;
preparing the enriching substances in a limited quantity of oil, sufficient to obtain a dispersion up to 100 times greater than the concentration to be obtained in the end product;
placing the oil in a stainless steel thermostatic tank complete with a mixer and a suitable nitrogen sparger that can guarantee a homogeneous dispersion of the gas in the oil;
mixing while transferring the solution of glycerol/water enriched with biophenols into the oil, by gravity from above;
optimizing the mixing rate up to the established maximum speed and maintaining this for 20-25 minutes, in order to obtain a fine emulsion (to guarantee an adequate homogeneity of the product, this sting process is also applied during the next step);
transferring the fine emulsion, again by gravity from above, into a further tank where the final concentration required for the end product is reached, with mechanical sting both during and after the addition of said fine emulsion, for at least 20-25 minutes in controlled temperature conditions and in the presence of a nitrogen sparger.

9. Method as claimed in claim 8, further comprising the addition of approximately 0.3% of monoesters of glycerol with fatty acids, such as oleic, palmitic or stearic.

10. (canceled)

11. A system for enriching and supplementing olive oils, even virgin and extra virgin olive oils, with natural extracts and organic additives, comprising:
a reactor of limited volume, associated with a mechanical mixer and with an ultrasound dissolving system for the treatment of the glycerol, water and polyphenol components;
a second tank of intermediate volume, for mixing a first quantity of oil with the mixture coming from said reactor, complete with a stirring system and a nitrogen sparger;
a third tank of larger capacity, with a further nitrogen sparger and a mechanical mixer, for mixing a second quantity of oil with the mixture coming from said second tank; and
a storage container in a nitrogen atmosphere.

12. (canceled)

13. Method as claimed in claim 3, wherein, during said mixing and adding stages at least, the product is submitted to the action of a flow of nitrogen.

14. Method as claimed in claim 2, further comprising addition of ascorbyl-6-palmitate (vitamin C palmitate) both as an antioxidant and to facilitate the solubilization of the biophenol extracts.

15. Method as claimed in claim 2, further comprising addition of mixtures of omega-3 fatty acids.
